(19) United States
(12) Patent Application Publication
(10) Pub. No.: US 2016/0082537 A1
(43) Pub. Date: Mar. 24, 2016

(54) METHODS OF REFINISHING SURFACE FEATURES IN BULK METALLIC GLASS (BMG) ARTICLES BY WELDING

(71) Applicant: Apple Inc., Cupertino, CA (US)

(72) Inventors: Douglas J. Weber, Arcadia, CA (US); Kazuya Takagi, Tokyo (JP)

(21) Appl. No.: 14/863,102

(22) Filed: Sep. 23, 2015

Related U.S. Application Data
(60) Provisional application No. 62/054,207, filed on Sep. 23, 2014.

(51) Int. Cl. B23K 9/04; B23K 15/08; B23K 26/342; B23K 9/23; B23K 26/362; B23K 26/402; B23K 9/013; B23K 15/00; B23K 26/00

(52) U.S. Cl. CPC B23K 9/042; B23K 15/0086; B23K 15/0093; B23K 15/08; B23K 26/342; B23K 26/0006; B23K 26/362; B23K 26/402; B23K 9/013; B23K 9/23; B23K 2203/50

(57) ABSTRACT

The present disclosure is directed to methods of refinishing surface features in bulk metallic glass articles by welding.

This application claims the benefit under 35 U.S.C. §119(e) of U.S. Provisional Patent Application Serial No. 62,054,207, filed Sep. 23, 2014, which is incorporated herein by reference in its entirety.

### TECHNICAL FIELD

The present disclosure is directed to methods of refinishing surface features in bulk metallic glass articles produced by welding.

### BACKGROUND

Bulk Metallic Glasses (BMGs) and precious metal versions (pBMGs) are metallic alloys that do not have a crystalline structure. Instead, like glass, their structure is amorphous. BMGs have a number of beneficial material properties that make them viable for use in a number of engineering applications. Some of the properties of the BMGs include high strength, elasticity, corrosion resistance and processability from the molten state.

BMGs, also referred to herein as amorphous alloys, are generally processed and formed by cooling a molten alloy from above the melting temperature of the crystalline phase (or the thermodynamic melting temperature) to below the “glass transition temperature” of the amorphous phase at “sufficiently fast” cooling rates, such that the nucleation and growth of alloy crystals is avoided.

When these BMG and pBMG materials are produced into articles, the fabrication processes may introduce surface features that may create voids in the BMG articles. Often surface features are only visible after costly raw materials have been consumed and hours of manufacturing processes have been performed.

### SUMMARY

In some aspects, described herein are methods for refinishing surfaces of a BMG or pBMG including, for example, refinishing surface features that create voids and/or regions of localized crystallization in BMG and pBMG articles.

In accordance with certain aspects, the disclosure relates to methods for refinishing surface features in BMG articles. In certain embodiments, the methods comprise applying a bulk metallic glass (BMG) filler material comprising an alloy composition the same as the alloy composition of the bulk metallic glass article to the surface feature such that the BMG filler material fills at least a portion of a void space created by the surface feature. Heating the BMG filler material and a portion of the BMG article adjacent the surface feature to a temperature above the melting temperature of the BMG filler material and BMG article to melt the BMG filler material and the portion of the BMG article adjacent the surface feature. Cooling the melted BMG filler material and melted portion of the BMG article adjacent the surface feature sufficiently fast to a temperature below the glass transition temperature of the metallic glass article without inducing substantial crystallization.

In other aspects, the disclosure relates to methods of removing localized crystallization in BMG articles. In certain embodiments the method may comprise heating a region of localized crystallization of the bulk metallic glass article to a temperature above the melting temperature to melt the region of localized crystallization. Then, cooling the melted region of localized crystallization of the bulk metallic glass article sufficiently fast to a temperature below the glass transition temperature of the metallic glass article without inducing substantial crystallization.

### BRIEF DESCRIPTION OF FIGURES

Although the following figures and description illustrate specific embodiments and examples, the skilled artisan will appreciate that various changes and modifications may be made without departing from the spirit and scope of the disclosure.

FIG. 1 shows a flow chart with the steps of the refinishing methods, in accordance with embodiments of the present disclosure.

FIG. 2A provides a schematic illustrating a BMG article with a surface feature, in accordance with embodiments of the present disclosure.

FIG. 2B provides a schematic illustrating a BMG article with a surface feature after a preheating treatment, in accordance with embodiments of the present disclosure.

FIG. 2C provides a schematic illustrating applying a BMG filler material to a BMG article with a surface feature, in accordance with embodiments of the present disclosure.

FIG. 2D provides a schematic illustrating exposing a BMG filler material and a portion of BMG article with a surface feature to a heating source, in accordance with embodiments of the present disclosure.

FIG. 2E provides a schematic illustrating cooling a BMG filler material and a portion of BMG article with a surface feature after being exposed to a heating source, in accordance with embodiments of the present disclosure.

FIG. 3A provides a schematic illustrating a BMG article with a hole, in accordance with embodiments of the present disclosure.

FIG. 3B provides a schematic illustrating a BMG article with a hole after a preheating treatment, in accordance with embodiments of the present disclosure.

FIG. 3C provides a schematic illustrating applying a BMG filler material to a BMG article with a hole after preheating steps, in accordance with embodiments of the present disclosure.

FIG. 3D provides a schematic illustrating exposing a BMG filler material and a portion of BMG article with a hole to a heating source, in accordance with embodiments of the present disclosure.

FIG. 4 provides a schematic of a time-temperature-transformation (TTT) diagram for an exemplary bulk solidifying amorphous alloy.

FIG. 5A provides a schematic illustrating applying an electron beam to a BMG article with both crystalline and amorphous phases, in accordance with embodiments of the present disclosure.

FIG. 5B provides a schematic illustrating removal of crystallization in a BMG article after being heated by an electron beam, in accordance with embodiments of the present disclosure.

FIG. 5C provides a schematic illustrating a BMG article with an amorphous layer after a polishing step, in accordance with embodiments of the present disclosure.

### DETAILED DESCRIPTION

The present disclosure is directed to methods for refinishing surface features in BMG materials and articles. BMGs, also referred to herein synonymously as amorphous alloys, are generally processed and formed by cooling a molten alloy from above the melting temperature of the crystalline phase (or the thermodynamic melting temperature) to below the “glass transition temperature” of the amorphous phase at “sufficiently fast” cooling rates, such that the nucleation and growth of alloy crystals is avoided. BMGs can refer, but do not necessarily refer, to amorphous alloys having or being capable of forming a specific thickness.

In certain aspects, the disclosure relates to methods for refinishing surface features in BMG articles. In certain aspects, the disclosure relates to methods for refinishing surface features, including those that create voids in BMG articles. Some examples of the types of surface features that can be refinished may be holes, craters, fissures, surface cracks, and regions of localized crystallization.

The BMG articles may be comprised of precious metal metallic alloy compositions such as gold (Au)-based alloys, platinum (Pt) based alloys, or palladium (Pd) based alloys. Alternatively, the BMG articles may be comprised of Nickel (Ni) based alloys, Iron (Fe) based alloys, Copper (Cu) based alloys, Zinc (Zi) based alloys, Zirconium (Zr) based alloys, or any other metal alloy capable of forming a bulk metallic glass.

In certain embodiments, the methods comprise applying a bulk metallic glass (BMG) filler material to a BMG article to at least partially fill voids. The BMG filler material comprises an alloy composition the same as the alloy composition of the bulk metallic glass article to the void such that the BMG filler material fills at least a portion of the void space. Both the BMG filler material and a portion of the BMG article adjacent to the void are heated to a temperature above the melting temperature of the BMG filler material and BMG article to melt the filler material and the portion of the BMG article adjacent to the void. Then, the melted BMG filler material and melted portion of the BMG article adjacent to the void is cooled sufficiently fast to a temperature below the glass transition temperature of the metallic glass article without inducing substantial crystallization.

In some aspects of the present disclosure, substantially free of crystallinity (or substantially amorphous) means that the volume fraction of crystals is less than 1%. In other embodiments it means the volume fraction of the crystals is less than 0.1%, while in yet other embodiments it means that the volume fraction of crystals is 0%.

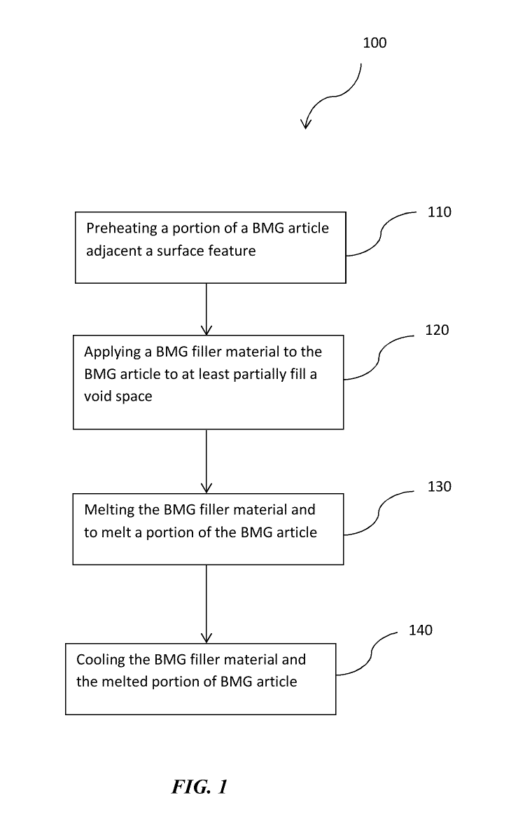

With reference to FIG. 1, a method 100 for refinishing a surface feature in a BMG article may include step 110 of preheating a portion of the BMG article adjacent to the void. Step 120 of applying a bulk metallic glass filler material to the BMG article to partially fill a void space. Step 130 of heating the bulk metallic glass filler material and a portion of the BMG article adjacent the void space. Step 140 of cooling the melted bulk metallic glass filler material and melted portion of the BMG article.

In various embodiments, in accordance with the present disclosure, surface features of at least 0.1 mm in size may be refinished using the described methods. Alternatively, surface features of at least 0.5 mm may be refinished using the methods described in accordance with the present disclosure. In other embodiments, surface features of at least 1 mm in size may be refinished using methods described herein.

In some embodiments, to refinish the surface feature, steps 120, 130 and 140 may be repeated successively. For example, if the steps of applying the BMG filler material, heating and melting the BMG filler material, and cooling the filler material are preformed and the void space created by the surface features in the BMG article remains, the steps can be performed repeatedly to substantially fill the void space. In some embodiments, substantially filling the void spaces means that at least 99% of the void space has been filled. In other embodiments, substantially filling means that at least 99.5% of the void space has been filled. Alternatively, substantially filled means that at least 99.9% of the void space has been filled.

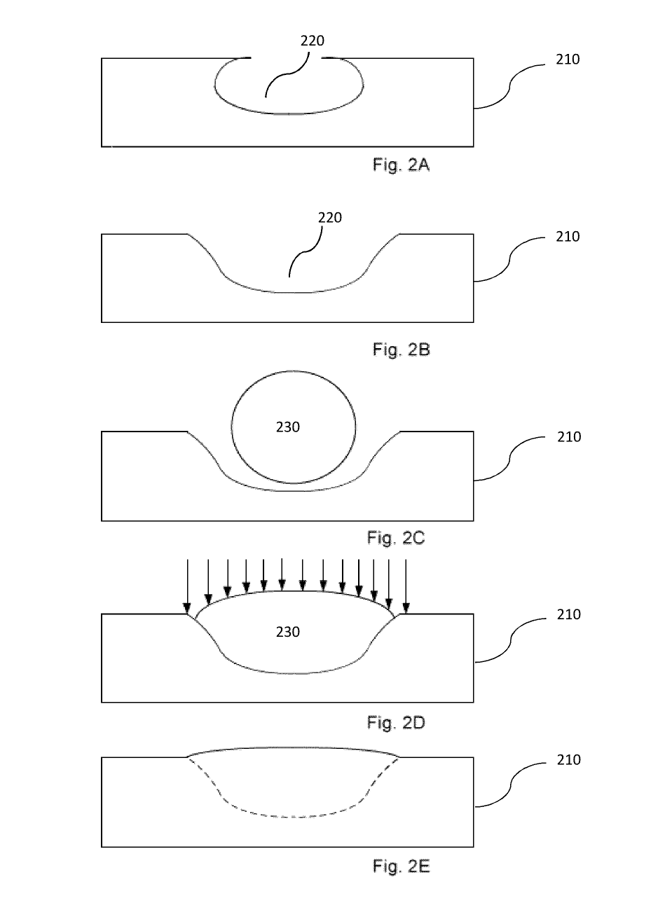

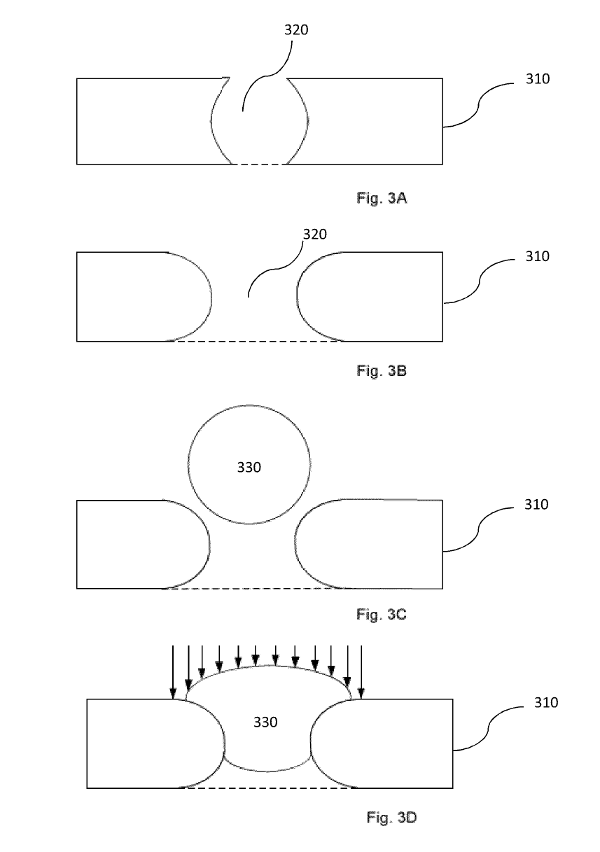

In other aspects, the method may comprise an optional step of preheating a portion of the BMG article adjacent the surface feature to prepare the BMG article for applying the BMG filler material. For example, as illustrated in FIGS. 2A and 3A, a surface feature 220 or 320 such as a crater or hole in the BMG article may be present and create surface edges between the BMG article and the void space of the surface feature. The surface edges surrounding the void space of the surface feature may be sharp and/or may conceal a portion of the void space. The surface edges may impede the ability of applying the BMG filler material to partially fill the void space of the surface feature. As such, in some embodiments, a step 110 of preheating and melting a portion of the BMG article adjacent the surface feature may be performed. The portion of the BMG article adjacent the surface feature in the context of the present disclosure includes a region of the BMG article that forms edges with the void space created by the surface feature.

To preheat and melt a portion the portion of the BMG article adjacent the surface feature, the portion of the BMG article adjacent the surface feature may be selectively exposed to a heating source. The heating source may be a laser, electron beam, an electrode or other source that has a controllable spot size and can provide energy sufficient to heat a portion of the BMG article to a temperature sufficient to melt the surface edges between the BMG article and the surface feature. The portion of the BMG article adjacent the surface feature may be exposed to the heating source for at least 5 milliseconds, for at least 10 milliseconds, for at least 20 milliseconds, or for at least 50 milliseconds. Alternatively, the BMG article may be exposed to the heating source for less than 50 milliseconds, for less than 25 milliseconds, for less than 10 milliseconds, or for less than 5 milliseconds.

The exposure time of the BMG article to the heating source depends on the composition of the alloy comprising the BMG article, the energy density of the heating source, and/or the spot size of the heating source. The exposure time may also depend on the number of pulses of the heating source projected on to the BMG article. Alternatively, the exposure time may depend on the time per pulse.

As illustrated in FIGS. 2B and 3B, preheating of the portion of the BMG article adjacent the surface feature may change the curvature of the edges between the BMG article and surface feature 220 and 320, thus exposing concealed portions of the void space. Exposing the void space allows for increased ease of applying the BMG filler 230 and 330 to the BMG article 210 and 310, and increased filling of the void space of the surface feature 220 and 320. In other embodiments, burrs may be present between the BMG article and the surface feature. The portion of the BMG article adjacent the surface feature having burrs may be preheated to a temperature sufficient to melt the BMG article to remove the burrs. Removal of the burrs adjacent the surface feature may allow for increased ease in applying the BMG filler material to at least partially fill the surface feature in the BMG article.

To refinish a surface feature containing a void space, a BMG filler material can be applied to the BMG article to fill at least a portion of the void space in the BMG article. In various embodiments, surface feature, including defects such as holes, craters, or cracks, whether visible or invisible to the naked eye, and can be refinished.

BMG articles can be inherently difficult to process, mold and solidify in the amorphous state without introducing surface features before crystallization begins. One factor that can accelerate or exacerbate the onset of crystallization is the grain structure of materials that may come in contact with the BMG during processing. For example, if the BMG article and BMG filler material had different compositions, phases and cooling rates, the filler material may act as a nucleation point for crystallization of the BMG. In order to maintain the substantially amorphous state of the BMG article, the BMG filler material may comprise the same alloy composition as the alloy composition of the BMG article so the cooling rates of the filler material and BMG article are comparable. Further, the BMG filler material can also be in an amorphous state. The BMG filler material should also be free of surface contaminants such as particles, oils or other debris. In some embodiments, the BMG filler may be pre-cleaned to remove any surface contaminations before applying the BMG filler material to the BMG article.

The bulk metallic glass filler material may be in sheet, wire, ribbon, pellet, powder or any other form that is known to one of ordinary skill in the art that is suitable for applying to the BMG article to at least partially fill the void space created by a surface feature in the BMG article.

As illustrated in FIGS. 2C and 3C, the BMG filler material 230 and 330 is applied to the surface feature 220 and 320 in the BMG article 210 and 310. The surface feature 220 can be a through hold that extends through the thickness of the BMG article. In other instances, the surface feature 320 can be a crate or crack in the BMG.

In some embodiments, the BMG filler material partially fills the void space in the BMG created by the surface feature. In other embodiments, the BMG filler material may substantially fill the void space. By applying the BMG filler material to partially fill the surface feature, upon heating and melting of the BMG filler, the filler material can flow freely and fill the void space to refinish the surface feature and have a near perfect BMG article free of cracks, craters, holes and other similar surface features. In some instances, the near perfect BMG article may have less than 1% void space by volume. In other instances the near perfect BMG article may have less than 0.5% void space by volume. In further embodiments, the near prefect BMG article may have less than 0.1% void space by volume.

To allow the BMG filler material to flow into the void space of the surface feature, the BMG filler material and a portion of the BMG article adjacent the surface feature are locally or selectively heated. The bulk metallic glass filler material and the portion of the BMG article are heated to a temperature to melt the bulk metallic glass filler material and to melt a portion of the BMG article. The BMG filler and BMG article may be selectively heated using laser welding, spot welding, arc welding or other suitable techniques that allow for controlling the size of the area of the BMG article that is exposed to heating source.

As described above, the exposure time of the BMG article and the BMG filler material to the heating source depends on the composition of the alloy comprising the BMG article, the composition of the alloy comprising the BMG filler, the energy density of the heating source, and the spot size of the heating source. The exposure time may also depend on the number of pulses of the heating source projected on to the BMG article. Alternatively, the exposure time may also depend on the heating rate (in K/sec), the energy per pulse, and/or the pulse duration.

As illustrated in FIGS. 2D and 3D, the BMG filler material and portion of the BMG article adjacent the surface feature are exposed to the heating source, while a remainder of the BMG article is not exposed to the heating source. The heating source may be a laser, an electrode or other source that has a controllable spot size and can provide energy sufficient to heat the BMG filler and a portion of the BMG article to a temperature sufficient to melt the BMG filler and a portion of the BMG article. The use of a laser or electrode as the heating source allows for localized heating and melting of the filler material and a portion of the BMG article. As such, the entire BMG article is not melted and the overall shape and integrity of the BMG article is retained during the refinishing process.

The types of lasers that may be used include CO₂ (carbon dioxide), CO (carbon monoxide) Nd:YAG lasers or any other suitable lasers.

In some embodiments, the BMG filler and portion of the BMG article may be exposed to the heating source for at least 5 milliseconds, for at least 10 milliseconds, for at least 20 milliseconds, or for at least 50 milliseconds. Alternatively, the BMG article may be exposed to the heating source for less than 50 milliseconds, for less than 25 milliseconds, for less than 10 milliseconds, or for less than 5 milliseconds.

In other embodiments, the BMG filler and portion of the BMG article may be heated by repetitive short bursts of exposure to the heating source. For example, a laser or electron beam may repetitively pulsed to provide energy to the BMG filler and BMG article for less than 10 milliseconds per pulse, for less than 5 milliseconds per pulse, and/or for less than 1 millisecond per pulse.

Without intending to be limited by any theory or mechanism of action, BMG alloys may be sensitive to oxygen content. For instance, oxides within an alloy may promote nucleation of crystals, thereby detracting from formation of an amorphous microstructure. Some amorphous alloy compositions form persistent oxide layers, which may interfere with the fusion of particles. Further, surface oxides may also be incorporated into the bulk alloy and may degrade the glass forming ability of the alloy. As such, in certain embodiments, it may be desirable to protect the BMG article in an inert atmosphere, a reducing atmosphere or in vacuum while the filler material is being heated, to remove oxygen from interfaces between the filler material and BMG article and from the final part. For example, the heating can be conducted in an enclosure under a vacuum (e.g., 1-10 mTorr), a reducing atmosphere (e.g., hydrogen or a mixture of hydrogen and nitrogen), or an inert atmosphere (e.g., argon, nitrogen). The enclosure can be pumped by an evacuation pump. Alternatively, an inert gas can be locally flowed to the BMG filler material and portion of the BMG article being heated by the heating source.

After heating, a cooling step 140 occurs. As referred to herein, cooling may include allowing the melted BMG filler material and melted portion of the BMG article to cool, at ambient temperature and atmosphere. In step 140, the melted BMG filler material and melted portion of the BMG article are cooled sufficiently fast to a temperature below the glass transition temperature of the BMG article and BMG filler without inducing substantial crystallization. The lowest rate by which a BMG can be cooled to avoid crystallization, thereby achieving and maintaining the amorphous structure during cooling, is referred to as the critical cooling rate for the bulk alloy.

In other embodiments, to cool sufficiently fast to a temperature below the glass transition temperature without inducing substantial crystallization, the BMG article may be pre-chilled or cold prior to applying the filler material. The BMG article can be pre-chilled by blasting with cooled air or any other suitable cooling method. It may be desirable to pre-chill the BMG article before applying the BMG filler material to create a negative heat sink so that heat is drawn away from the melted BMG filler and the melted portion of the BMG article.

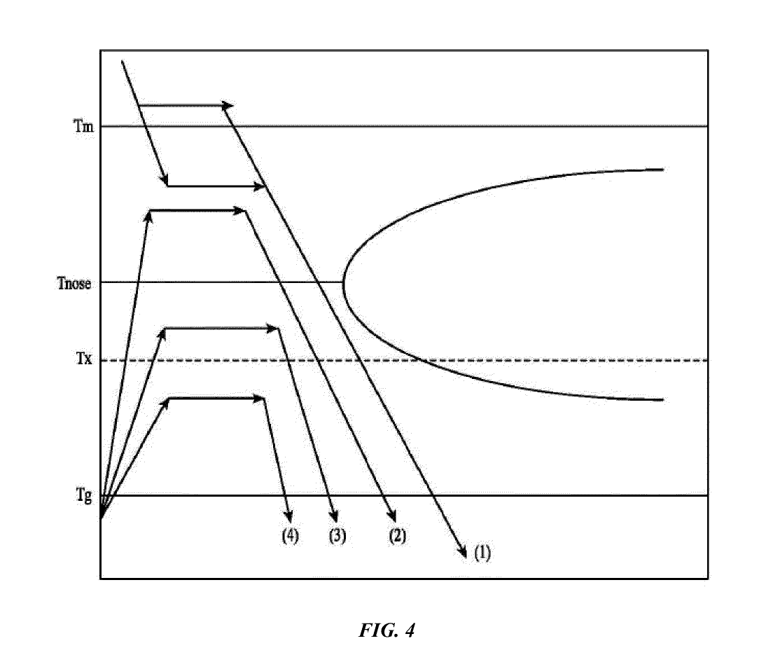

FIG. 4 (obtained from U.S. Pat. No. 7,575,040, incorporated herein by reference) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non-crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a melting temperature Tm may be defined as the thermodynamic liquidus temperature of the corresponding crystalline phase. Under this regime, the viscosity of bulk-solidifying amorphous alloys at the melting temperature may lie in the range of about 0.1 poise to about 10,000 poise, and even sometimes under 0.01 poise. A lower viscosity at the “melting temperature” would provide faster and complete filling of the void space caused by the surface features in the BMG articles. Furthermore, the cooling rate of the molten BMG filler and portion of the BMG article has to be such that the time-temperature profile during cooling does not traverse through the nose-shaped region bounding the crystallized region in the TTT diagram of FIG. 4. In FIG. 4, Tnose is the critical crystallization temperature Tx where crystallization is most rapid and occurs in the shortest time scale.

The supercooled liquid region, the temperature region between Tg and Tx, is a manifestation of the stability against crystallization of bulk solidification alloys. In this temperature region the bulk solidifying alloy can exist as a high viscous liquid. The viscosity of the bulk solidifying alloy in the supercooled liquid region can vary between 10¹² Pa s at the glass transition temperature down to 10⁵ Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

Technically, the nose-shaped curve shown in the TTT diagram describes Tx as a function of temperature and time. Thus, regardless of the trajectory that one takes while heating or cooling the BMG filler and portion of the BMG article, when one hits the TTT curve, one has reached Tx. In FIG. 4, Tx is shown as a dashed line as Tx can vary from close to Tm to close to Tg.

The schematic TTT diagram of FIG. 4 shows processing methods of die casting from at or above Tm to below Tg without the time-temperature trajectory (shown as (1) as an example trajectory) hitting the TTT curve. During die casting, the forming takes place substantially simultaneously with fast cooling to avoid the trajectory hitting the TTT curve. The processing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in a more controllable process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats an amorphous alloy but does not intersect the TTT curve, the alloy is heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TTT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 4, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as the processing temperature increases.

In other embodiments, localized crystallization can be removed from BMG articles. The methods comprise heating of the localized crystalline portion of the BMG article to remelt the localized crystalline portion of the BMG article and cooling sufficiently fast to a temperature below the glass transition temperature of the BMG article without inducing substantial crystallization. The localized crystalline portion of the BMG article can be heated using any of the heating sources described above. All variations described herein for refinishing or refinishing BMG articles having a surface feature may be used here.

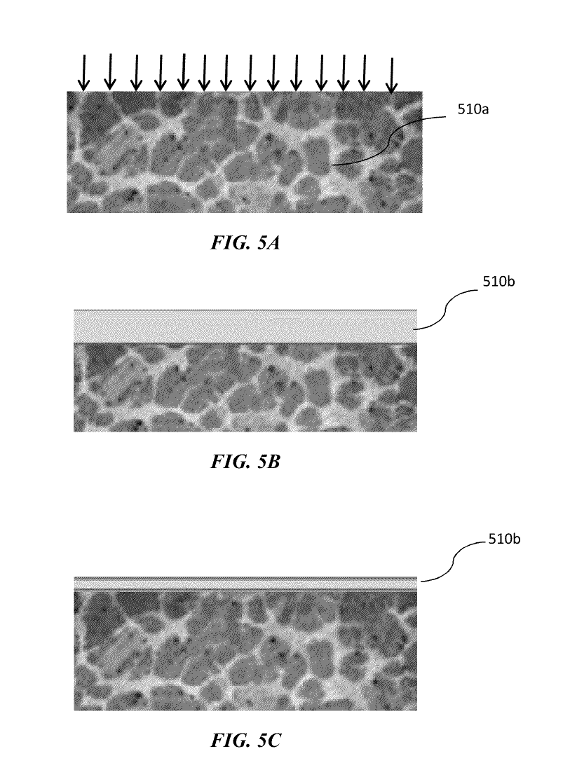

Without intending to be limiting, by way of example, regions of localized crystallization may be visible on an exterior surface of the BMG article. As illustrated in FIG. 5A, regions of crystallization 510a may be present along with the amorphous phase in a BMG article. In some embodiments, to remove the localized crystallization on the exterior surface, an electron beam may be applied to the localized crystallization and a portion of the surface of the BMG article. The electron beam provides a source of energy capable of melting at least a portion of the exterior surface of the BMG article.

In some embodiments, the electron beam may penetrate the BMG article to depths of up to 5 μm thereby heating and remelting the localized crystallization as illustrated in FIG. 5B showing removal of the crystallization after the electron beam has been applied. The BMG article may be treated with an electron beam for a short processing time (e.g. at least a few milliseconds). In some embodiments, the electron beam may penetrate the BMG article to depths of at least 1 μm, in other embodiments to depths of at least 4 μm. In other embodiments, the electron beam may penetrate the BMG article to depths equal to or less than 5 μm, in other embodiments the penetration depth may be equal to or less than 4 μm. In further embodiments, a laser or electrode may be used as the heating source. A laser or electrode may penetrate the BMG article to depths greater than 5 μm and in some embodiments to depths greater than 10 μm.

After heating and melting the localized crystalline portion of the BMG article, it is cooled sufficiently fast to a temperature below the glass transition temperature of the BMG article without inducing substantial crystallization thereby forming a substantially amorphous exterior surface 510b, as illustrated in FIG. 5. In some embodiments, substantially amorphous means that the volume fraction of crystals is less than 0.1%. In other embodiments it means the volume fraction of the crystals is less than 0.05%, while in yet other embodiments it means that the volume fraction of crystals is 0%. In some embodiments, the surface of the BMG article may be further polished as shown in FIG. 5C.

In alternative embodiments, the methods described in accordance with the present disclosure may be used for reinforcing the BMG article. In some embodiments, to reinforce the BMG article, the methods comprise applying a BMG filler material to a BMG article to at least a portion of the BMG article. Heating the BMG filler material and the portion of the BMG article to which the BMG filler was applied to a temperature above the melting temperature of the BMG filler material and BMG article to melt the filler material and the portion of the BMG article to which the BMG filler was applied. Then, cooling the melted BMG filler material and melted portion of the BMG article to which the BMG filler was applied sufficiently fast to a temperature below the glass transition temperature of the metallic glass article without inducing substantial crystallization. All variations described herein for refinishing BMG articles having a surface feature may be used here.

In further embodiments, the methods described in accordance with the present disclosure may be used for additive manufacturing of a BMG article. By way of an example, without intending to limit the method to specific BMG articles, the methods described herein may be used for joining at least two BMG articles, such as a boss and a housing. In some embodiments, the BMG filler material may be applying to the surfaces joining at least two BMG articles. Heating the BMG filler material and the at least two BMG to a temperature above the melting temperature of the BMG filler material and the at least two BMG articles to melt the filler material and melt at least a portion of the at least two BMG article to which the BMG filler was applied. Then, cooling the melted BMG filler material and melted portions of the at least two BMG article to which the BMG filler was applied sufficiently fast to a temperature below the glass transition temperature of the metallic glass article without inducing substantial crystallization. All variations described herein for refinishing BMG articles having a surface feature may be used here.

The methods herein can be valuable in the fabrication of electronic devices using a BMG-containing part. An electronic device herein can refer to any electronic device known in the art. For example, it can be a telephone, such as a mobile phone, and a land-line phone, or any communication device, such as a smart phone, including, for example an iPhone®, and an electronic email sending/receiving device. It can be a part of a display, such as a digital display, a TV monitor, an electronic-book reader, a portable web-browser (e.g., iPad®), and a computer monitor. It can also be an entertainment device, including a portable DVD player, conventional DVD player, Blue-Ray disk player, video game console, music player, such as a portable music player (e.g., iPod®), etc. It can also be a part of a device that provides control, such as controlling the streaming of images, videos, sounds (e.g., Apple TV®), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

While this disclosure has been described with reference to specific embodiments, it will be understood by those skilled in the art that various changes may be made and equivalents may be substituted for elements thereof, without departing from the spirit and scope of the disclosure. In addition, modifications may be made to adapt the teachings of the disclosure to particular situations and materials, without departing from the essential scope thereof. Thus, the disclosure is not limited to the particular examples that are disclosed herein, but encompasses all embodiments falling within the scope of the appended claims.

1. A method of refinishing a BMG article having a surface feature, the method comprising:
applying a BMG filler material to a surface feature wherein the BMG filler material comprises an alloy composition the same as the alloy composition of the BMG article;
heating the BMG filler material and a portion of the BMG article adjacent the surface feature to a temperature above the melting temperature of the BMG filler material to melt the filler material and the portion of the BMG article adjacent the surface feature; and
cooling the melted BMG filler material and melted portion of the BMG article adjacent the surface feature sufficiently fast to a temperature below the glass transition temperature of the metallic glass article without inducing substantial crystallization.

2. The method of claim 1, wherein the BMG filler material fills the entirety of a void space created by the surface feature.

3. The method of claim 1, wherein the surface feature is at least 0.1 mm.

4. The method of claim 1, wherein the surface feature is at least 0.5 mm.

5. The method of claim 1, wherein the surface feature is at least 1 mm.

6. The method of claim 1, wherein the heating step is performed using a laser, electron beam, or an electrode.

7. The method of claim 1, wherein the BMG filler material is in an amorphous state.

8. The method of claim 1, wherein the BMG filler material is a sheet, wire, ribbon, pellet, or powder.

9. A method of removing a region of localized crystallization in a BMG article comprising:
heating the region of localized crystallization of the BMG article to a temperature above the melting temperature of the BMG to melt the region of localized crystallization; and
cooling the melted region of localized crystallization of the BMG article sufficiently fast to a temperature below the glass transition temperature of the metallic glass article without inducing substantial crystallization.

10. The method of claim 9, wherein the region of localized crystallization is at least 0.1 mm.

11. The method of claim 9, wherein the region of localized crystallization is at least 0.5 mm.

12. The method of claim 9, wherein the region of localized crystallization is at least 1 mm.

13. The method of claim 9, wherein the heating step is performed using a laser, electron beam, or an electrode.

14. A method of refinishing a portion of a surface feature of a BMG article, the method comprising:
at least partially filling the surface feature with a BMG filler material;
melting the BMG filler material and a portion of the BMG article adjacent the surface feature; and
cooling the BMG filler material and portion of the BMG article adjacent the surface feature sufficiently fast to a temperature below the glass transition temperature of the BMG without inducing substantial crystallization.

15. The method of claim 14, wherein the BMG filler material fills the entirety of a void space created by the surface feature.

16. The method of claim 14, wherein the surface feature is at least 0.1 mm.

17. The method of claim 14, wherein the surface feature is at least 0.5 mm.

18. The method of claim 14, wherein the surface feature is at least 1 mm.

19. The method of claim 14, wherein the heating step is performed using a laser, electron beam, or an electrode.

20. The method of claim 14, wherein the BMG filler material is in an amorphous state.
